(19) United States
(12) Patent Application Publication
(10) Pub. No.: US 2005/0021265 A1
(43) Pub. Date: Jan. 27, 2005

(54) Method for reducing the measurement requirements for the dynamic response of tools in a CNC machine

(76) Inventor: Donald M. Esterling, Carrboro, NC (US)

Correspondence Address: Donald M. Esterling, 201 Stable Road, Carrboro, NC, 27510-4144, US

(21) Appl. No.: 10/805,438

(22) Filed: Mar. 19, 2004

Related U.S. Application Data
(60) Provisional application No. 60/456,947, filed on Mar. 25, 2003.

(51) Int. Cl. G06F 19/00

(52) U.S. Cl. 702/76

(57) ABSTRACT

The present invention provides a method for determining the Frequency Response Function for a collection of tools in a CNC machine by taking four measurements (three of which are independent) on a single tool, held in the same or similar tool holder, spindle and CNC machine. The method uses inverse Receptance Coupling Substructure Analysis (RCSA) to obtain the receptances of the system, exclusive of the single tool. Standard (forward) RCSA is then used with these receptances and certain analytic expressions for the receptances of a freely supported tool to obtain the FRF for each tool in the collection of tools. This information can be used to predict stable, chatter-free depths of cut over a range of spindle speeds in CNC machining, identifying both the limiting depth of cut at any speed as well as special spindle speeds where unusually large, chatter-free depths of cut are available.

### CROSS-REFERENCE TO RELATED APPLICATIONS

The present application is entitled to the benefit of U.S. Provisional Application No. 60/456947 filed Mar. 25, 2003, the entire disclosures and contents of which are hereby incorporated by reference.

### BACKGROUND OF THE INVENTION

### Common Abbreviations and Terms

The following are abbreviations and terms that will be used in portions of this application. For convenience, the abbreviations and terms are collected here for reference. Details on the particular meaning of each term may be found at the first use of the term.

CNC Computer Numerical Control

Type of machine tool whose operation is controlled by a computer. May also refer to the control itself or to the programming language used by the control.

FRF Frequency Response Function

Linear relation between an applied force and the resulting system displacement, expressed in the frequency domain. “Receptance” and Frequency Response Function may be used interchangeably. A particular term is used depending on the context and conventional usage for that context.

RCSA Receptance Coupling Substructure Analysis

Method for obtaining the Frequency Response Function for a compound system from the Frequency Response Functions of the components of the system.

### FIELD OF THE INVENTION

This invention relates to generally to CNC (computer numerical control) programming and machining. The invention is a new method for greatly reducing the measurement requirements for the dynamics of a CNC machine and its tooling, as expressed in the Frequency Response Function.

### BACKGROUND

CNC programming consists of generating computer commands that are passed to a machine tool that has a CNC control. The commands instruct the control on what tool paths the machine tool should take and sets various machining conditions such as the feed, or speed the tool cuts into the part, and spindle speed, or the speed with which the tool rotates when cutting the part. There are many factors that can influence whether the as-machined part meets specifications. These include incorrectly programmed tool paths (e.g. tool gouging into a design surface), tool wear causing the actual cutting surface to be off-set from the expected cutting surface, and too aggressive feed values causing—for example—the tool to break or chip. These and similar factors may be classified as “static” errors. Another class of machining errors is related to “dynamic” or vibrational effects.

The Frequency Response Function (FRF) is a measure of the CNC machine dynamics and is integral to determining the effect of machine dynamics on machining errors and part quality as explained by J. Tlusty in Manufacturing Processed and Equipment, Prentice Hall, Upper River Saddle, N.J. (2000); the entire contents and disclosures of which are hereby incorporated by reference.

Part errors may be due to forced vibrations or due to an instability in the cutting process known as chatter. The invention is specific to the determination of the Frequency Response Function and these two sources of part errors are offered only as important examples of the use of the Frequency Response Function in CNC machining

There is a well established literature on chatter and its linkage to the dynamics of the CNC machine and its tooling as described in Y. Altintas, Manufacturing Automation (Cambridge University Press, 2000), the entire contents of which are hereby incorporated by reference. This dynamic information can be used to predict the safe depth of cut. The safe depth of cut depends strongly on the spindle speed as shown schematically in FIG. 1. A safe manufacturing operation could maintain depths of cut below D_Limit (as shown in FIG. 1) or the operator can achieve much larger depths of cut and higher productivity, by operating at or near certain spindle speeds (e.g. S1 as shown in FIG. 1). Altintas summarizes decades of chatter research that demonstrates that both the limiting depth of cut (D-Limit) and the special spindle speeds (e.g. S1) depend on the dynamics of the CNC machine and its tooling as encoded in the FRF.

### DESCRIPTION OF PRIOR ART

The dynamics effecting forced vibrations and chatter involves the dynamics of a coupled system: the CNC machine proper, the CNC spindle, the tool holder, the tool itself and, at times, the dynamics of the part being machined as described, for example, by Altintas. Our method will exclude consideration of the part dynamics, the latter either being measured independently or, more commonly, the part dynamics is not significant relative to the dynamics of the rest of the system. The dynamics of the system is characterized by the Frequency Response Function (FRF).

The current state of the art is to measure the FRF of the coupled CNC machine, spindle, tool holder and tool in every possible combination. For each combination, the end of the tool is manually struck with a calibrated force hammer, inducing a time-varying displacement (Altintas). The combination of the time history of the impact force and the displacement can be used to determine the dynamics of that particular tool in that particular system. These manual measurements can be difficult to perform, lack repeatability, require specialized equipment and analysis and so require a trained expert.

Certain new measuring devices have recently been developed that make the process substantially simpler, specifically the non-contact device patented by Davies, U.S. Pat. No. 6,349,600, the entire contents and disclosures of which are hereby incorporated by reference and the non-contact device of Esterling, U.S. Provisional Patent Application No. 60/456948 “Device for Measuring the Dynamic Response of a Tool in a CNC Machine” filed Mar. 25, 2003, the entire contents and disclosures of which are hereby incorporated by reference.

The method is applicable both to currently available and newly developed devices for measuring the Frequency Response Function of a CNC machine and its tooling, providing a measurement process and related theory that greatly reduces the number of required measurements.

A typical CNC may have as many as 50 to 100 tools in its tool carrel, leading to a large number of measurements (one for every tool, tool holder, spindle, CNC machine combination). The present invention greatly reduces the number of required FRF measurements by taking measurements for one tool and using the present method to obtain reliable Frequency Response Functions for an entire collection of tools. The measurements may be taken using the conventional calibrated force hammer or use the simpler measuring device of Esterling. Use of the present invention, along with the novel and simple measuring device developed by Esterling, will simplify the process of obtaining the dynamics of the CNC system to a level that will be accessible to any conventionally trained CNC operator. The dynamic information can then be used, in conjunction with conventional chatter theory (Altintas) to provide a simple and reliable chatter prediction and avoidance system.

The method builds on a technique known as “receptance coupling substructure analysis” (RCSA). The text by R. E. D. Bishop and D. C. Johnson, The Mechanics of Vibration, Cambridge University Press (1979), the entire contents which are hereby incorporated by reference, provides an excellent and readable introduction to RCSA. The term “receptance” as used by Bishop and Johnson is, for our purposes, equivalent to “Frequency Response Function.” We will follow normal convention and use the term “receptance” in the context of RCSA theory.

In RCSA, the receptance of a compound system is obtained from the receptances of the individual subsystems. In this invention, the system is decomposed into the tool and the rest of the complex (tool holder, spindle, CNC machine). Bishop and Johnson provide analytic expressions for the receptances of simple beams. Treating the tools as beams then provides us with the receptance of the tool sub-system, given the tool geometry and material properties. If we have the receptance of the rest of the complex, we can use RCSA along with the Bishop and Johnson expressions for the tool receptances to obtain the total system (compound) receptance for a variety of tools sited in the same or similar CNC machine, spindle and tool holder.

There are two strategies for finding the receptance of the top complex, exclusive of the tool itself. Schmitz and collaborators (Schmitz, T. L., Davies, M. A. and Kennedy, M. D., “Tool Point Frequency Response Function Prediction for High Speed Machining by RCSA,” J. of Mfg. Sci. and Tech., Trans. of the ASME, Vol. 1123, pp. 700-707, 2001; Schmitz, T. L. and Burns, T. J., “Receptance Coupling for High-Speed Machining Dynamics Prediction,” Proc. Of the 2003 Int. Modal Analysis Conf. (IMAC-XXI), Feb. 3-6, 2003, the entire contents and disclosures of which each hereby incorporated by reference) have combined measurements of the spindle and CNC machine receptance with a phenomenological model of the tool holder receptance to estimate the receptance of the top complex consisting of the CNC machine, spindle and tool holder. Our invention uses FRF measurements for the receptance of a particular compound system (a particular tool) along with “inverse RCSA” to obtain the receptance of the top complex. Both methods proceed to obtain the receptance of a collection of tools by combining the receptance of the top of the complex with analytic expressions for the receptance of the tool subsystem to obtain receptances and FRFs for a collection of tools. Thus, in both methods, the operator is freed from making FRF measurements for every tool in the CNC machine carrel.

There are important theoretical and practical differences between our invention and the Schmitz technique. The details will be presented in the Detailed Description of the Preferred Embodiment Section. The first difference is that Schmitz, et al. only employ RCSA in the “forward” direction. In so doing, they must measure or estimate the dynamics of each of the system components (CNC machine+spindle, tool holder), but do not need to measure the dynamics of the individual tool inserted in the CNC. Our method uses RCSA in both the “forward” and “inverse” directions so that, as a practical matter, the operator does not need to make separate measurements and/or estimates of the dynamics of the CNC machine and spindle and of the tool holder. In our method, the operator simply takes measurements as usual on a single tool inserted in the tool holder, spindle, CNC machine. The “inverse RCSA” solution determines the dynamics of the rest of the system complex, exclusive of the tool. We then use the usual “forward” RCSA to combine the dynamic information of this subsystem along with analytic expressions for the dynamics of any tool to obtain the total system dynamics for a collection of tools.

The second key difference is that, to obtain a solution, Schmitz et al. must make very strong (and, as we will detail) incorrect assumptions about the spindle/tool holder FRF. Consequently, their method results in certain phenomenological parameters related to the tool holder dynamics that vary as the tool geometry is changed. In the preferred RCSA method, the dynamics and properties of each sub-system (in this case, the tool holder sub-system and the tool sub-system) should be independent and de-coupled from each other. The dynamics of the tool holder, spindle and CNC machine should be described by tooling-independent parameters. These tooling-independent parameters are then used with RCSA to obtain the dynamics for different tools sited in the same or equivalent environment CNC machine, spindle, tool holder). If, however, the parameters for the top complex (subsystem exclusive of the tool) vary with each tool in the collection of tools, then the method may be considered as more of a curve fitting process rather than as a method based on firm fundamentals of RCSA. In an example case given by Schmitz, the stiffness of the tool holder varies by a factor of four and the damping by a factor of ten as the tool length is changed. This severe dependence of the parameters of the top complex (the system excluding the tool) on the tool geometry is, alone, a strong indication of the breakdown in the Schmitz use of RCSA. Further evidence regarding certain deficiencies in the Schmitz assumptions is provided in the Examples Section, where the results from the Schmitz analysis are compared to results for an exactly soluble system.

Our method is completely general and does not require the Schmitz assumptions. We demonstrate that our method can predict the dynamics of a collection of tools using tooling-independent parameters obtained from measurements on a single tool. In the Example Section our results coincide, within numerical precision, with the results for an exactly soluble system.

### SUMMARY OF THE INVENTION

The present invention provides a simplified method for measuring the dynamics of a tool situated in a CNC machine. Specifically, the method takes certain dynamic measurements for a single tool and obtains the dynamics for a collection of tools. The particular dynamic information of interest is encoded in the “Frequency Response Function” or FRF which is a measure of the response of the system to an applied force.

The applied force may be an impulse in the time domain (e.g. standard calibrated hammer tests as in Altintas) or may be a sinusoidally varying force as in the Esterling device. Each type of force leads to a time-varying displacement. Each variable (force and displacement) may be converted to the frequency domain via a Fourier Transform. The ratio of the displacement to the force in the frequency domain is known as the Frequency Response Function (FRF) (Altintas).

The present invention determines the FRF for any of several tools sited in the same or equivalent environment (CNC machine, spindle, tool holder) from FRF measurements on a single tool, also sited in the same or equivalent environment. There are three tooling-independent parameters representing the dynamics of the environment as required by RCSA to obtain the FRF for a particular tool. The present invention will measure three independent FRFs for a single tool and use inverse RCSA to obtain these three tooling-independent parameters. These three tooling-independent parameters are then used with standard (“forward”) RCSA to obtain the FRF for a multiplicity of tools sited in the same or equivalent environment.

It is therefore an object of the present invention to provide a method for determining the Frequency Response Function of a collection of tools sited in a CNC machine from the measurements of the Frequency Response Functions of a single tool sited in the same CNC machine with a similar tool holder.

Other objects and features of the present invention will be apparent from the following detailed description of the preferred embodiment.

### DETAILED DESCRIPTION OF THE PREFERRED EMBODIMENT

### Definitions

For the purposes of the present invention, the term “machine” includes machines employing cutting tools such as: milling tools, lathe tools, etc. For the purposes of the present invention, the term “machining” refers to methods employing machine tools.

For the purposes of the present invention, the term “lathe tool” refers to any cutting tool, generally fixed, for cutting material that rotates relative to the cutting tool.

For the purposes of the present invention, the term “milling tool” refers to a cutting tool that rotates relative to the material the cutting tool cuts.

For the purposes of the present invention, a “spindle” refers to a device for rotating a milling tool, a lathe test bar, a milling test bar, a piece of material mounted on a lathe, etc.

For the purposes of the present invention, “Frequency Response Function” is a function of frequency, having both real and imaginary components, which specifies both the magnitude and phase shift of the displacement response of a tool sited in a CNC machine relative to an applied sinusoid force at the particular frequency.

### Rationale

Chatter in machining is a self-excited vibration of the workpiece and/or tool that can result in poor surface finish, increased rates of tool wear and potential damage to the machine and/or workpiece. Chatter can occur though a variety of mechanisms including regenerative chatter, mode coupling and impact dynamics. Regenerative chatter is caused by a force-feedback mechanism that occurs when a previously cut surface is re-cut by a subsequent machining operation. The force-feedback depends on the chip thickness encountered by a tooth on the tool. If the tool or workpiece are vibrating, then the nominal position of the tool/tooth varies relative to the workpiece. If, for example, the tool is momentarily away from its nominal center position, a cutting tooth will leave a shallower cut than nominal. A subsequent tooth, encountering the just cut surface may then, depending on the tool center position, have to make a deeper than normal cut. The fluctuations in chip thickness depend on the vibrations of the tool/workpiece and the rotational speed of the spindle. For milling, the spindle holds the rotating tool. For turning, the spindle holds the rotating workpiece. The force-feedback, and possibly resulting instability, depends—among other factors—on the vibrational frequency of the tool/workpiece relative to the spindle speed. Several computational methods exist to predict regenerative chatter, under certain ideal cutting conditions as summarized by Altintas. Other chatter mechanisms include mode coupling (Tlusty) and impact dynamics, the latter best described by M. Davies, et. al., The Stability of Low Radial Immersion Milling, Annals of the CIRP, vol. 49(1), 37-40 (2000).

In order to predict chatter due to any of these mechanisms, it is necessary to know the dynamics of the machine tool and workpiece. This is normally expressed as the Frequency Response Function, which relates the time-varying displacement of the entity in response to a time-varying force.

The best spindle speeds—those most immune to regenerative chatter—are related to the natural frequencies of the CNC machine (Davies). The natural frequencies correspond to peaks in the Frequency Response Function. Our invention will determine the Frequency Response Function over a range of frequencies and, by doing so, identify the peaks needed to predict optimal spindle speeds.

Frequency response functions for machine tool structures are usually obtained by applying a force to the tool by hitting it with a calibrated hammer. The calibrated hammer provides a known impulsive input force. The resulting displacements are measured with a sensor and the entire measurement information is fed into an analyzer. The calibrated hammer requires some dexterity and experience for successful use. The resulting analysis requires some expertise in dynamic measurement and theory. These tests and their interpretation could not be expected of a typical shop floor machinist.

Recently, Esterling has developed a simpler, non-contact device for measuring the FRF of a tool situated in a CNC machine. Combining this device with the present invention will greatly simplify the overall dynamic measurement process.

### Description: Standard RCSA Results

Our method starts from certain well-known results from Receptance Coupling Substructure Analysis or RCSA as given by Bishop and Johnson and by Schmitz. The compound system (CNC machine, spindle, tool holder and tool) is composed of two sub-systems, “A” and “B.” The CNC machine, spindle and tool holder are considered as a single sub-system “B”. The “A” sub-system consists of the tool extending from the B sub-system. The tool is completely general, but has known geometry and material properties. (Most tools are made from steel or carbide, with geometry and material properties provided by the tool vendors). The usual practice for finding the FRF of the tool sited in the CNC is to strike the tool with a force F1 at position Z1 near the bottom of the tool with a resulting displacement X1 orthogonal to the tool axis. The ratio of X1 to F1 in the frequency domain is the tool FRF that is the end objective for this and related dynamic measurement methods.

RCSA states that the FRF of a linear elastic compound system may be obtained from the FRFs (called “receptances” by Bishop and Johnson) of each individual component. RCSA provides certain linear relationships between the independent variable (the applied force F1) and various dependent variables. The dependent variables are: X1 (displacement at the tip of the tool), X2 (displacement at the interface between A and B), X1p=dX1/dZ (the angle of the tool with respect to the tool axis at the tip of the tool) and X2p=dX2/dZ (the angle of the tool with respect to the tool axis at the interface of A and B). Following Schmitz, et al., the RCSA linear relationships are:
X1=a1*F1+a2*f2+a3*m2 [1]
X2=a4*F1+a5*f2+a6*m2 [2]
X1p=a7*F1+a8*f2+a9*m2 [3]
X2p=a10*F1+a11*f2+a12*m2 [4]

In these relationships, a1, a2 . . . are certain FRFs (receptances) for the tool and f2, m2 are the induced force and moment at the A-B interface. As shown in Bishop and Johnson, the receptances a1, a2 . . . are “free-free” receptances and have known, analytic expressions (also given in Bishop and Johnson) by treating the tool as a beam with given geometry and material properties. All of these equations are in the frequency domain, so X1 . . . X2p, F1, f2, m2, a1, a2 . . . are each functions of frequency.

The induced forces and moments (f2 and m2) are, as yet, undetermined and depend on the boundary condition for the tool A. This involves sub-system B whose FRFs (receptances) b1, b2 and b3 at the A-B interface can also be written in a linear fashion as in Schmitz as:
X3=b1*f3+b2*m3 [5]
X3p=b2*f3+b3*m3 [6]

The equality of the receptance coefficient of m3 in equation [5] and the receptance coefficient of f3 in equation [6] follows from an RCSA reciprocity condition in Bishop and Johnson. X3 and X3p are the X displacement and slope of B at the A-B interface. As in the previous equations, all variables are functions of frequency. The receptances b1, b2 and b3 depend on what is in the “black box” (sub-system B) and its boundary condition.

Continuing to follow standard RCSA analysis, these expressions may be combined using compatibility (X2=X3, X2p=X3p) and equilibrium (f2+f3=0, m2+m3=0) conditions. Specifically, Equations [5] and [6] may be re-written as:
X2=−b1*f2−b2*m2 [5.1]
X2p=−b2*f2+b3*m2 [6.1]

Traditional (“forward”) RCSA then proceeds by [1] equating equations [5.1] to [2] and [6.1] to [4] to find the induced force and moment (f2 and m2) in terms of the applied force F1 and the receptances (a1, a2, . . . b1, b2 and b3 ) and [2] determining the FRFs (receptances) b1, b2 and b3 (e.g. by direct measurement). Substituting the receptances b1, b2 and b3 into equation [1] we finally obtain X1 in terms of F1 or, equivalently, the tool tip FRF X1/F1. Similarly, equation [3] can be used to find the related tool tip FRF: X1p/F1.

The resulting relationships between X1 and F1 and between X1p and F1 are somewhat complicated. For reference, we will reproduce the X1/F1 expression below in equations [7] and [8]. Similar expressions may be derived for the X1p/F1 FRF as well as two other tip FRFs (X1/M1 and X1p/M1), where M1 is an applied moment at the tool tip. These expressions are of value when using RCSA in the forward (conventional) direction. The X1/F1 FRF expression is reproduced here to give a sense of the forward RCSA solution method (to wit, though the expressions are complex, a numerical solution is feasible). Most importantly, the expressions are non-linear in the “top” (B) receptances b1, b2 and b3. This will be an important consideration for the inverse RCSA method.

The compound receptance of a tool at its tip due to an applied force at its tip when coupled to a system with receptances b1, b2 and b3 is:
X1/F1=ALL−AOL²*(ALpLp+b3)/determ+AOL*AOLp*(ALLp−b2)/determ+AOL*AOLp*(ALLp−b2)/determ−AOLp²*(ALL+b1)/determ [7]
determ=(ALL+b1)*(ALpLp+b3)−(ALLp−b2)²[8]

In this expression, we have replaced the a1, a2, . . . receptances in equations [1] through [4] with the free-free analytic tip receptances, obtained from Bishop and Johnson and using a notation similar to that used by Bishop and Johnson: Aij=receptance of the free-free beam (tool) A for a force applied at Z=Zj and a displacement measured at Z=Zi. Zi=“L” refers to the tip of the tool and Zi=“O” refers to the top of the tool (the interface between the tool and the rest of the complex). A “p” for the row index (i) indicates the displacement is replaced by a slope (dX/dZ). A “p” for the column index (j) indicates the receptance is due to a moment, not a force, at the indicated location. All of the receptances (ALL,AOL, . . . ) are tabulated by Bishop and Johnson as analytic expressions. For later reference, note is taken that the X1/F1 FRF depends on the top complex (B) receptances (b1, b2 and b3) in a non-linear fashion, as a ratio of polynomials in b1, b2, b3 and their cross products.

The main point of Equations [7] and [8] is that, if we know the receptances of the sub-system B (b1, b2 and b3 ), we can find the receptance of the compound system (A+B) as expressed by the function X1/F1. Up to this point, this is a restatement of prior art. This is a reproduction of standard (“forward”) RCSA as used, for example, by Schmitz and collaborators.

### Use of RCSA to Obtain the FRF for Multiple Tools

Schmitz and collaborators use standard RCSA results to obtain the Frequency Response Function for multiple tools. They decompose the “B” system (all of the CNC system exclusive of the tooling) into components consisting of the tool holder and “everything else” (the spindle and CNC machine). They measure the equivalent of the “b1” receptance of the spindle fixtured in the machine tool. They infer the receptances of the tool holder and the coupling of the tool holder to the spindle and to the tool by measuring the FRFs for tools of various lengths and making a best fit to a simplified dynamic model of the tool holder. The simplified model is equivalent to assuming the “b2” term used in the above expressions is zero and the “b3” term can be treated by an explicit and simplified expression. The latter expression for b3 is intended to take into account a torsional mode in the tool holder.

With these assumptions, Schmitz et al. can obtain the Frequency Response Function for multiple tools in the same spindle and similar tool holder by combining the measured spindle Frequency Response Function, inferring the tool holder Frequency Response Function and using the analytical expressions for the tool in RCSA to obtain the Frequency Response Function for the compound system.

These assumptions are made because Schmitz et al. do not have any direct way to measure all of the needed receptances of the tool holder and its coupling to the spindle and to the tool. These are very strong assumptions. We will show they are incorrect for some very simple compound systems. A symptom of the problem is that their derived tool holder receptances depend on the geometry of the tool inserted into the tool holder. This should not be the case. In the preferred application of RCSA, the receptances of each sub-system should be independent of other sub-systems. With the Schmitz assumptions, the receptance of the tool holder sub-system depends on an entity external to that sub-system, the tool geometry. This dependence is indicative of a breakdown in their key assumptions, most specifically that certain receptances can be set to zero.

### Description: Inverse RCSA Method

A robust and practical RCSA should be based on tooling-independent parameters for the top (“B” or spindle+tool holder) sub-system. We will show that the Schmitz assumptions are not necessary. Through a novel “inverse RCSA” we will determine all of the receptances of the “B” system (b1, b2 and b3) through a set of linear equations. This will provide a method to reliably determine the FRF of a collection of tools. The single tool measurement provides the top (“B”) receptances and standard (forward) RCSA is used to find the Frequency Response Function for any tool in the same spindle and similar tool holder by combining the tooling-independent top (“B”) receptances with analytical expressions for the base (“A”) tool-specific receptances.

Our strategy will be to take four FRF measurements on a single tool. The four measurements will be:
X1/F1 (displacement at X1 due to a force at Z1) [M1]
X2/F1 (displacement at X2 due to a force at Z1) [M2]
X1/F2 (displacement at X1 due to a force at Z2) [M3]
X2/F2 (displacement at X2 due to a force at Z2) [M4]

Z1 is a location along the tool axis near the tool tip. Z2 is a location along the tool axis near the top of the tool (close to where the tool meets the tool holder).

Due to reciprocity relationships in Bishop and Johnson, two of these FRFs will be equal (X2/F1=X1/F2). This leaves three independent measurements to find our three independent variables (the three receptances of the B system: b1, b2 and b3).

The key insight is to note that, using these three independent measurements, equations [2] and [5] can be combined to produce a linear relationship of the form:
r*b1*s*b2=t [9]
where r, s and t are depend on known (analytic free-free receptances of the tool) or measured (X1/F1, X2/F1) quantities. Similarly, equations [4] and [6] can be combined to produce a linear relationship of the form:
r*b2*s*b3=u [10]
and again, u is known from X1/F1, X2/F1 and the free-free receptances of the tool. The detailed expressions can be derived, much as equations [7] and [8] by suitable application of algebra. Explicit expressions follow.

Using the data from X1/F2 and X2/F2 and equations similar to [1] through [6] but with the force F2 applied at Z2, we also obtain the relations:
R*b1*S*b2=T [11]
and
R*b2*S*b3=U [12]

The expressions for R, S, T, U involve the measured variables (X1/F2), (X2/F2) and certain analytic free-free receptances. Of the four relationships [9] through [12], only three are linearly independent, due to the reciprocity condition.

The expressions for r,s,t,u, R,S, T and U are complex. But the functions are all known and easily evaluated numerically. Equations [9] through [12] provide a linear relationship for the “top” receptances b1, b2 and b3. This is in stark contrast to the highly non-linear relationship between b1, b2 and b3 and the receptances X1/F1, X1p/F1, X1/M1 and X1p/M1. (Although we omit the latter expressions, they are as complex and as non-linear as equations [7] and [8]).

The solution for b1, b2 and b3 is trivial, using equations [9] through [12 ].
b1=(S*t−s*T)/(S*r−s*R) [13]
b2=(r*T−R*t)/(S*r−s*R) [14]
b3=(r*U−R*u)/(S*r−s*R) [15]

For reference, the expressions for r,s,t,u, R, S, T and U in terms of the free-free receptances (al, a 2, . . . ) and the measured receptances (X1/F1 . . . . X2/F2 )) are:
r=−(a6*a1+a3*a4+a6*(X1/F1)−a3*(X2/F1) [16]
s=(a5*a1−a2*a4)−a5*(X1/F1)+a2*(X2/F1) [17]
t=−X2*(a2*a6−a3*a5) [18]
u=−a10*(a2*a6−a3*a5)−a11*r−a12*s [19]
R=−(A6*A1+A3*A4+A6*(X1/F2)−A3*(X2/F2) [20]
S=(A5*A1−A2*A4)−A5*(X1/F2)+A2*(X2/F2) [21]
T=−X2*(A2*A6−A3*A5) [22]
U=−A10*(A2*A6−A3*A5)−A11*R−A12*S [23]

In these expressions, the free-free receptances A1, A2, . . . are similar to the a1,a2, . . . free-free receptances in Equations [1-4], with the exception that the force on the free-free beam (tool) is applied at the top of the tool (Z2) not at the bottom (Z1). Exact, analytic expressions may be found for the free-free receptances using the methods of Bishop and Johnson.

The measurements of the FRFs X1/F1 through X2/F2 do not require any new procedure. The FRFs may be obtained with the standard calibrated hammer impact measurement technique or with the Esterling non-contact technique. This is an advantage of the method since the measurement technique is already well established. Conventional FRF measurement requires the X/F measurement for every tool in the tool carrel. Our inverse RCSA method takes a single tool and makes four X/F measurements. (One of the measurements is redundant and can serve as a consistency check on the measurement process). These measurements are used to determine tooling-independent receptances of the CNC machine/spindle/tool holder complex (“b1, b2, b3”) which can then be used with standard (forward) RCSA (e.g. Equations [7] and [8]) to obtain the receptances of tools which share a common or similar CNC machine, spindle and tool holder type. The result is substantial reduction in required FRF measurements.

The measurements will need to be repeated for different tool holders, spindles and CNC machines. Experience may show similarities and/or trends for similar tool holders, spindles and CNC machines. A tabulation of such results could lead to an even greater simplification of the FRF measurement process.

The method entails measuring the FRFs under four conditions ([M1], [M2], [M3] and [M4]) for a particular tool (T1) and then using inverse RCSA followed by standard (forward) RCSA to obtain the FRF for any tool situated in the same or similar tool holder, spindle and CNC machine. In principal, the method works for any tool (T1) as the tool used for the measurements. In practice, the standard tool (T1) should be a cylindrical rod with simple geometry. The simple geometry leads to relatively simple and reliable free-free receptances (a1 . . . , A1, . . . ) for the standard tool, as used in equations [13]-[23]. The top portion of the rod (e.g. the top one inch) may be considered as part of the B “top subsystem”) as it is not usually practical to apply a force or take displacement measurements exactly at the tool—tool holder interface, due to interference from the tool holder overhang. This is not a problem for the method, as the “A” subsystem is then taken as the portion of the tool below this upper section of the rod.

This will introduce a small variation of the “B” sub-system receptance for tools with densities and/or diameters that differ from the standard tool, due to the mass of the tool in the tool holder itself as well as the section just below the tool holder and now considered as part of the “B” subsystem. This mass effect is easily incorporated into the method, since the effect of a point mass (a reasonable approximation for the effect of the short tool section on the very massive tool holder/spindle) on FRFs is well known and documented, for example, in Bishop and Johnson. So the “mass effect” of any tool can be subtracted out of the FRF relationships for tool T1 and incorporated into subsequent FRF evaluations for tools with different densities or diameters.

For completeness, we present two alternate methods to find the tooling-independent receptance parameters (b1, b2, b3). Any three independent measurements of the FRFs of a compound system should yield the required tooling independent receptances of the “top” component (B). The first alternate method takes measurements on two tools of different lengths (L1 and L2). A force is applied at the tip of each tool and the displacement is measured both at the tip and at the A/B interface (top of the tool). This provides four FRF measurements, only three of which are independent and can be used to determine the three tooling-independent receptance parameters (b1, b2 and b3). The fourth measurement may be used as a consistency check on the first three and the overall RCSA relationships. In common with our standard method, the resulting equations are linear and are easily solved for the unknown tooling-independent receptances. For this first alternate method, the force is only applied at the tip. The resulting displacements are larger than when the force is applied near the top of the tool as in our standard method. The larger displacements in the first alternate method may result in the alternate method being less sensitive to experimental noise. The disadvantage of the first alternate method is the need to take measurements on two, rather than one, tool.

The second alternate method uses equations [7] and [8] and similar relations for other FRFs (X1p/F1, X1/M1 and X1p/M1) along with the measured values of the X1/F1, X1p/F1, X1/M1 and X1p/M1 FRFs to determine the tooling-independent parameters b1, b2 and b3. As noted, due to the Bishop and Johnson reciprocity condition, the X1p/F1 FRF is (within experimental precision) equal to the X1/M1 FRF. The dependent FRF may be used as a consistency check on the other three independent FRFs.

There are two drawbacks to the second alternate method. First, the measurements of the X1p/F1, X1/M1 and X1p/M1 FRFs are not as simple as measuring an X/F type of FRF. The X1p/F1 FRF (X1p=dX1/dZ)) requires measuring the slope of the tool at its tip. The X1/M1 and X1p/M1p FRFs requires measuring the X axis displacement and slope of the system responding to a moment applied at the tool tip. In principal, these measurements can be made, In practice, they are very difficult since they involve very small differences (slopes) and/or a moment which is difficult to apply at the tool tip even for a large diameter tool. Further, even if these measurements were made, the solution of the coupled non-linear equations for the tooling-independent receptances is considerably more difficult, is fraught with technical problems (multiple solutions to the non-linear equations with only one physical solution, convergence is never assured) and is more sensitive to experimental noise than solutions using the linear equations [9] through [12].

### EXAMPLE

The method will be demonstrated using an example compound system with computer-generated data. A cylindrical beam with a cantilever end condition will be used to generate the FRF (or receptance) for a sample system. The beam will be considered as composed of two sections. The top (“B”) section will be attached to a fixed boundary (cantilever end condition). The lower (“A”) section will be attached to the upper B section. The B section represents the CNC machine, spindle, tool holder and a short section of the tool. The A section represents a tool extending beyond the short tool section.

For simplicity, the tooling in both sections will have the same diameter (D). The lower section will have length La and the upper section will have length Lb. Both sections will have a diameter of 0.5 inches with material properties representative of 1018 steel. The modulus E for each section will be 30.04*10⁶ psi. The density is 0.284 lb per cubic inch. In order to model damping, we will consider the elastic modulus to have a small imaginary part or E=E(steel)*(1+0.03*i). The method works equally well if the upper section has a different diameter, modulus and/or density.

The advantage of this particular example is that we have exact expressions for all of the receptances (FRFs) and so can test the method with sample data based on these expressions, free of experimental noise and uncertainty. These expressions can be obtained from the analytic results in Bishop and Johnson (Table 7.1 (c)) as well as the more general analytic results in Milne (H. K. Milne, The Receptance Functions of Uniform Beams, J. of Sound and Vibration, vol. 131, pp. 353-365 (1989), the entire contents and disclosures of which are hereby incorporated by reference. The FRFs at the top and the bottom of the “A” section for a particular length La play the role of the measured data. This gives us the four displacements due to forces at the top and the bottom of the A section (measurements [M1], [M2], [M3] and [M4]). These “measurements” on the compound (A and B) system can be used in our inverse RCSA equations to obtain a predicted value for the FRFs (b, b2 and b3 in the preceding equations) of the top “B” section alone.

The same analytic expressions can be used to compute the exact FRFs for a cantilever beam of length Lb. These should be, and indeed are, precisely the same as the FRFs (b1, b2, b3) predicted by the inverse RCSA method starting from the four compound beam measurements ([M1] through [M4]).

The “B” sub-system FRFs can then be used in standard (forward) RCSA to predict the dynamic response of an A+B compound system, where now the length of the A sub-system (La) can vary from the value used to obtain the B system FRFs.

The Schmitz strategy is equivalent to setting the “b2” FRF to zero and severely constraining the “b3” FRF to a certain phenomenological form (representing a torsional spring with a single internal mode). We will demonstrate potential problems with the Schmitz solution strategy by comparing the FRFs for a compound beam based on exact results, based on our inverse RCSA results and based on the Schmitz assumptions. For simplicity, we will only invoke one of the two Schmitz assumptions, setting the b2 FRF to zero but retaining the exact value for the b3 FRF.

The results are summarized in the Table 1 and were obtained using the cantilever beam as a testbed example. The magnitude of the frequency shift with and without the Schmitz assumption depends, of course, on the geometry and associated receptances of the sub-systems.

Table 1 is a list of the natural frequencies for a compound system. The natural frequency corresponds to the frequency where the real part of the FRF crosses zero (2,3). Only the first (dominant) mode is considered. For various combinations of sub-system lengths (La and Lb), the Table presents the natural frequencies based on different methods and assumptions.

The lengths in Table 1 are all in inches. The total length of the beam is La+Lb. The tabular values are the natural frequencies in Hertz.

The column labeled f(exact) is a list of the exact analytic expressions for the receptance of the cantilever beam which are equal to those predicted natural frequencies based on [a] use of our inverse RCSA method to obtain the “B” sub-system FRFs and then [b] using forward RCSA to obtain the FRF for the compound system and the associated natural frequency. Since the results predicted by the inverse RCSA followed by a forward RCSA are the same as the exact results (to the numeric precision of the program, in our case this is 10⁻²⁰), there is no separate column for these values.

TABLE 1
Comparison of the Natural Frequencies of a Cantilever Beam
of Length La + Lb With and Without Schmitz Assumption (b2 = 0)

| | | | |
|---|---|---|---|
| f (exact) | f (b2 = 0) | Δf | Δf/f |

Lb = 0.5

| | | | | |
|---|---|---|---|---|
| La = 2.0 | 2261 | 2462 | 201 | 9% |
| La = 3.0 | 1154 | 1209 | 55 | 5% |
| La = 4.0 | 698 | 719 | 21 | 3% |
| La = 5.0 | 467 | 471 | 10 | 2% |

Lb = 1.0

| | | | | |
|---|---|---|---|---|
| La = 2.0 | 1571 | 1902 | 331 | 21% |
| La = 3.0 | 884 | 1000 | 116 | 13% |
| La = 4.0 | 565 | 615 | 50 | 9% |
| La = 5.0 | 393 | 418 | 25 | 6% |

Lb = 2.0

| | | | | |
|---|---|---|---|---|
| La = 2.0 | 884 | 1160 | 276 | 31% |
| La = 3.0 | 565 | 718 | 153 | 27% |
| La = 4.0 | 393 | 475 | 82 | 20% |
| La = 5.0 | 288 | 336 | 47 | 16% |

The exact FRFs (b1, b2 and b3) for a cantilever beam with a short length (0.5 to 2 inches) are relatively flat and featureless over the frequency range of interest (0 to 2 kHz). The resonant frequency is well above the frequencies listed in Table 1. For Lb=1 inch, b1 (X/F) is approximately 2.1*10⁻⁷ m/N, b2 (X/M) or (X′/F) is approximately 1.2*10⁻⁶ m and b3 (X′/M) is approximately 9.6*10⁻⁷ N-m. The variation in the values of b1, b2 and b3 is less than 1% over the frequency range of 0 to 2 kHz with a slight increase with increasing frequency. The exact (frequency dependent) values were used to obtain the results in Table 1.

The column labeled f(b2=0) are predictions using the exact B sub-system FRFs in a forward RCSA calculation, but invoking one of the two key Schmitz assumptions: the “b2” FRF is set to zero. The last two columns in Table 1 (Δf and Δf/f) are the differences between the exact natural frequency and that obtained under the Schmitz assumption of setting the b2 FRF to zero and the percentage difference.

The “B” system FRFs may be used to obtain the FRF of a compound system (length La+Lb) using equations [7] and [8] for the X1/F1 FRF. FIG. 2 shows the resulting compound system FRF for a cantilever beam consisting of lengths La=3 inches and Lb=1 inch (total length 4 inches). In FIG. 2, the solid line shows the real part of the FRF obtained by using the exact (analytic) FRFs for the B section in conjunction with the equations [7] and [8]. Alternatively, we could have displayed the FRF for a simple beam of total length 4 inches and/or the FRF using our inverse RCSA method. All three of these FRFs are equal to the numeric precision of the program. Note that the individual FRFs that go into the RCSA formula for the compound FRF are quite different. The “B” (top section) FRFs are relatively flat and featureless. The free-free receptances used to model the lower (“A”) subsystem are singular as frequency goes to zero and monotonically decrease as frequency increases. These combine to yield an FRF with a proper resonance at the natural frequency as shown by the solid line in FIG. 2.

This combination of very different FRFs within RCSA to produce a resonance at the correct natural frequency depends critically on all functions being properly determined. If, as in Schmitz, certain functions are arbitrarily set to zero or to improper, constrained values, then the resulting FRF can be quite wrong.

This is shown by the dashed line in FIG. 2 which shows the real part of the compound beam FRF computed using “Schmitz” B sub-system FRFs (b1 and b3 exact, b2=0) and the forward RCSA (equations [7] and [8]). The deviation of the natural frequency (zero crossing of the real part of the FRF) is apparent by comparing the solid and dashed FRF plots. This plot corresponds to the Lb=1 inch, La=3 inch in Table 1 with natural frequencies of 884 Hz (solid line FRF) and 1000 Hz (dashed line FRF).

The advantage of our inverse RCSA method is that we can obtain the needed “B subsystem” FRFs with no special assumptions and using only linear relationships, removing the uncertainties and imprecision of a numerical solution of non-linear equations. Further, the needed measurements are standard displacement over force FRF measurements, albeit with the forces and displacements set at unique locations. The only uncertainties are the inherent imprecision of any measurement.

### BRIEF DESCRIPTION OF THE DRAWINGS

The invention is described in conjunction with the accompanying drawings, in which:

FIG. 1 is a chart showing regions of stable and unstable machining conditions. Chatter occurs in the unstable regions shown in grey. The vertical axis represents the depth of cut for a machining operation. This depth may represent either the axial or radial depth of cut for milling or the radial depth of cut for turning. The horizontal axis represents the spindle speed. Chatter occurs when the depth of cut is too large for a particular spindle speed. D_Limit indicates a depth of cut that is chatter free at all spindle speeds. S1 indicates a special spindle speed where an unusually large depth of cut can be made without chatter.

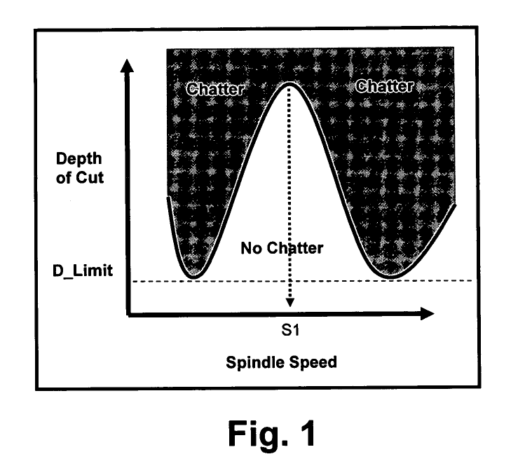

FIG. 2 is a chart showing the real component of the X/F frequency response function for 1018 steel cantilever beam, length 4″, diameter 0.5″. The vertical axis is the frequency response function. The horizontal axis is the frequency. The solid line is the exact result. Dashed line is the result under the assumption that the receptance b2 is zero.

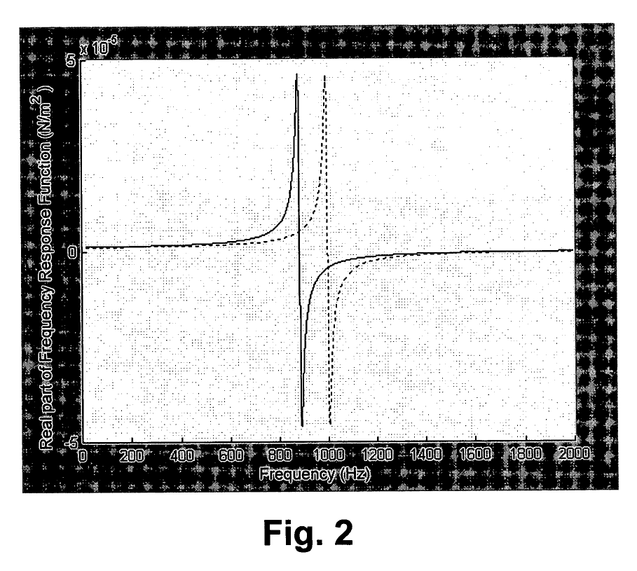

The advantage of our inverse RCSA method is that we can obtain the needed “B subsystem” FRFs with no special assumptions and using only linear relationships, removing the uncertainties and imprecision of a numerical solution of non-linear equations. Further, the needed measurements are standard displacement over force FRF measurements, albeit with the forces and displacements set at unique locations.

1. A method for determining the Frequency Response Function (FRF) of a tool in a CNC machine, comprising of the steps:
a. Measuring four distinct displacement to force FRFs for a single tool, with the displacements measured at the top and bottom of the tool and the force applied at the top and the bottom of the tool.
b. Two of these measurements are equal (to the precision of the measurements and so long as the system is linear) due to reciprocity conditions, leading to three independent measurements and a fourth measurement that may be used as a consistency check.
c. Application of the four FRF measurements in an inverse RCSA method to obtain the FRF functions for the system, exclusive of the tool.
d. The inverse RCSA method involves solving a set of linear equations, avoiding the ambiguities and difficulties of solving non-linear equations.
e. The FRF functions for the system, exclusive of the tool, is used in standard (forward) RCSA to obtain the FRF for any tool in the same or similar tool holder, spindle and CNC machine.

2. The method greatly simplifies the measurement process for tool FRFs as threer FRF measurements on a single tool can then be used to obtain the FRFs for a large collection of tools sharing the same spindle and a similar tool holder.

3. The Frequency Response Functions for each tool sited in the CNC can be used, in conjunction with chatter prediction theory, to identify stable depths of cut as a function of spindle speed, to identify a limiting depth of cut that is stable at any spindle speed as well as special spindle speeds which display unusually large chatter free depths of cut.
